(19) United States
(12) Patent Application Publication
(10) Pub. No.: US 2026/0235313 A1
(43) Pub. Date: Aug. 13, 2026

(54) COMPENSATING FOR DRIFT IN PRESSURE SENSORS

(71) Applicant: Airthings ASA, Oslo (NO)

(72) Inventors: Dag Mattis Pettersen, Oslo (NO); Andreas Bolstad, Oslo (NO); Roc Ballesteros Pujol, Oslo (NO)

(73) Assignee: Airthings ASA, Oslo (NO)

(21) Appl. No.: 19/538,756

(22) Filed: Feb. 12, 2026

(30) Foreign Application Priority Data
Feb. 13, 2025 (GB) 2502169.2

(51) Int. Cl. F24F 11/63; F24F 11/30; G01L 9/12

(52) U.S. Cl. CPC F24F 11/63; F24F 11/30; G01L 9/125

(57) ABSTRACT

A system and method for compensating for drift in pressure measurements of a first sensor and a second sensor, wherein the drift is at least partially temperature dependent. Data is acquired when active ventilation does not contribute to differences in measured pressure between the first sensor and the second sensor. The data includes a plurality of values of each of: the first pressure; a first temperature associated with the first sensor; the second pressure; and a second temperature associated with the second sensor. For a plurality of times, the following are obtained: i) the first temperature at that time, ii) the second temperature at that time, and iii) a pressure difference between the first pressure at that time and the second pressure at that time. Curve fit analysis is preformed to obtain a calibration function of the pressure difference as a function of the first and second temperatures.

### CROSS-REFERENCE TO RELATED APPLICATIONS

This application claims priority from United Kingdom Patent Application No. 2502169.2, filed Feb. 13, 2025, which application is incorporated herein by reference in its entirety.

### BACKGROUND OF THE INVENTION

This disclosure relates to a system and method for compensating for drift in pressure sensor measurements for example in ventilation systems.

In the field of building ventilation systems, it is often important to be able to measure the difference in pressure between the inside and the outside of the building, as well as the differences in pressure between any ventilation zones within the building. In some zones it may be required that the differential pressure between inside the zone and outside the zone is kept at either a positive or negative pressure for various reasons. For example, maintaining a positive pressure environment by injection of clean, filtered air will result in air leakage across the zone boundary being predominantly out of the zone, thus decreasing contamination. Many buildings use a balanced ventilation system, which tries to keep the differential pressure stable across the building envelope. However, many factors can affect this and it can be difficult to measure the differential pressure accurately.

Dedicated differential pressure sensors are usually deployed in buildings to measure these differential pressures accurately. However, these differential pressure sensors typically have a tube extending between the two areas (e.g. extending from inside to outside the building), within which a diaphragm is located, and the deflection of the diaphragm away from its resting state can be used to determine the differential pressure between the two areas. These sensors therefore require holes through the building envelope (or through other zone boundaries). This increases the cost of installation and limits the number of such sensors, especially when retrofitting to older buildings.

According to a first aspect of the present invention there is provided a method for compensating for pressure measurement drift of a first sensor and a second sensor, wherein the drift is at least partially temperature dependent, and wherein the first sensor is configured to measure a first pressure and the second sensor is configured to measure a second pressure, the method comprising:
acquiring data during a time period in which active ventilation does not contribute to differences in measured pressure between the first sensor and the second sensor, the data comprising a plurality of values of each of: the first pressure; a first temperature associated with the first sensor; the second pressure; and a second temperature associated with the second sensor;
for each of a plurality of times in the time period, obtaining from the data:
   i) the first temperature at that time,
   ii) the second temperature at that time, and
   iii) a pressure difference between the first pressure at that time and the second pressure at that time; and
performing a curve fit analysis to obtain a calibration function of the pressure difference as a function of at least the first temperature and the second temperature.

According to this method, instead of using a single differential pressure sensor which requires exposure to both pressures simultaneously, two absolute pressure sensors can be used to calculate the pressure difference, with one pressure sensor exposed to one pressure and the other pressure sensor exposed to the other pressure. One problem with absolute pressure sensors is that the measurements from each sensor drift independently of each other which reduces the accuracy of the calculated pressure difference. The drift of such sensors can be sufficiently large that differential pressure measurements are not reliable enough for good building management. The two sensors cannot easily be calibrated against one another as active ventilation within the building or zone also affects the pressure reading. Thus it is impossible to know how much of the measurement is due to active ventilation and how much is due to sensor drift. The method described here addresses how to compensate for the drift of absolute pressure sensors to increase their accuracy and allow them to be used, for example, for differential pressure measurements.

Pressure sensors (i.e. sensors that measure an absolute pressure) will experience drift due to a variety of factors, including time dependent drift, and drift due to other atmospheric variables e.g. temperature and/or humidity. The temperature dependent drift of pressure sensors can however be the most dominant effect, at least over the short term. A raw pressure measurement (P_{measured}) from a sensor will therefore be a combination of the actual pressure (P_{actual}) and the drift contribution (P_{drift}) which can be expressed as:

$${P}_{measured} = {P}_{actual} + {P}_{drift}$$

It will be appreciated that when taking any two pressure sensors, the difference in their measured pressure may be due to a number of different factors, due to both the actual pressure and the drift contribution. One important factor is sensor height. Where the two sensors are placed at different heights, this will typically result in different actual pressures. Similarly, where the two sensor locations experience different active ventilation, they will measure different actual pressures. At the same time, each sensor experiences its own drift due to time, temperature, humidity, etc.

According to the method described here, the contribution of different active ventilation is eliminated by acquiring measurements from both sensors during a time period when active ventilation does not contribute to the pressure difference between the two sensors. This removes the most significant and most problematic contributor to differences in actual pressure between the sensors. The other significant contributor to actual pressures is height, but it should be noted that in many cases there will be no height contribution, e.g. if the sensors are mounted at the same height. This would be the case where for example the two sensors are replacing the functionality of a typical through-hole differential pressure sensor where the hole would typically extend horizontally through a wall (so there is no height difference). In other cases, even if there is a height difference, this can be more easily calibrated (or compensated) by obtaining accurate measurements of the heights of the two sensors. Thus, by removing the effect of active ventilation (and if necessary, also removing the effect of height), the remaining differences will be due to drift alone. The method described here recognises that temperature drift is the most significant and thus obtains several measurements of temperature and pressure while active ventilation is not contributing so as to be able to calibrate the sensor pair for temperature-dependent drift. Once this calibration has been performed, it can be used even when active ventilation is affecting the sensors. For example, by taking temperature measurements for each sensor, the calibration function can be used to obtain a value of the pressure difference due to sensor drift at those temperatures and this can be subtracted from the measured pressure difference to obtain a more accurate measurement of the actual pressure difference.

In some embodiments the first sensor and the second sensor may be located in the same building zone. It will be appreciated that a zone is a region in a building which is reasonably isolated (in a ventilation sense) from other regions in the building. For example, two zones may be sufficiently isolated from one another that different pressures can be maintained in the different zones. Zones need not be completely airtight, but are sufficiently sealed such that airflow between them is restricted (e.g. so that a pressure difference can be maintained). For example, different floors in a building may act as different zones if there is adequate isolation between them (although some flow will be present through leaks or via stairwells, lift shafts, etc.). Different areas of a floor may also be different zones (e.g. different offices on the same floor, each with its own (e.g. normally closed) entrance, and each with different ventilation schemes). Different rooms within a floor (and even within an office) may act as different zones and this may be desired for certain areas such as server rooms, labs, etc. which have specific requirements. A building with a single ventilation system for the whole building may be considered as a single zone. However, if the same building were to have different areas with different ventilation areas it may have multiple zones. Similarly, the outside of a building (which has no ventilation system) can be considered to be a different zone to the inside of a building which has a ventilation system. However, if the ventilation systems in a building are turned off, the zones will start to equalise through natural air leakage between them. Once the zones are equalised in this manner, they can all be considered as a single zone. Eventually, in the absence of any environmental control within a building, the inside will equalise with the outside, at which point the inside and outside of the building may be considered as a single zone.

If two sensors are located in the same building zone, even when ventilation is active in the zone, the active ventilation will not necessarily contribute to differences in measured pressure (unless for example one sensor is placed in much closer proximity to a fan of the ventilation system than the other sensor). However, in many interesting scenarios, the two pressure sensors are not placed in the same building zone, e.g. where they are being used to determine differential pressure across a zone envelope or zone boundary. Therefore, in some embodiments the first sensor and the second sensor are located within different ventilation zones. These zones may have different environmental control, e.g. different active ventilation.

Another factor which can create differences within zones is the stack effect, also known as the chimney effect or natural draught effect. This occurs when there is a temperature difference between two (adjacent) zones and results in a varying pressure gradient across the zone (for example across the building envelope), varying with height. For example, when a building (one zone) is warmer than the outside (typical in winter), warm air rising within the building creates a higher pressure at the top of the building than at the bottom of the building. In the absence of any other active ventilation, this stack effect will result in air flowing into the building (negative pressure) at the bottom and air flowing out of the building (positive pressure) at the top. The opposite happens when the inside of the building is cooler than the outside (typical in summer). There will be a neutral pressure level at some height where there is no pressure difference between inside and outside. Active ventilation can alter this pressure gradient, moving the neutral pressure level up or down (even to a level above or below the limits of the building's height).

The difference in measured pressure of two sensors for any selected time can be expressed as:

$$Δ {P}_{m e a s u r e d} = {P}_{1 , actual} - {P}_{2 , actual} + {P}_{1 , drift} - {P}_{2 , drift}$$

where ΔP_{measured} is the pressure difference between the first pressure and the second pressure, P_{1,actual} is the actual pressure at the first sensor, P_{2,actual} is the actual pressure at the second sensor, P_{1,drift} is the pressure measurement contribution due to sensor drift of the first sensor, and P_{2,drift} is the pressure measurement contribution due to sensor drift of the second sensor. As this data is taken at a time when there is no active ventilation, and if for simplicity we take an example where there are no other contributions to pressure difference (e.g. the sensors are at the same height and there is no stack effect), then it can be assumed that the difference between the actual pressure at the first pressure sensor and the second pressure sensor is zero, so:

$${P}_{1 , actual} - {P}_{2 , a c t u a l} = 0$$

$$Δ {P}_{m e a s u r e d} = {P}_{1 , drift} - {P}_{2 , drift}$$

As it is known that the measured pressure values vary with temperature (i.e. drift is temperature dependent), a curve fit can then be performed to establish the relationship between the two temperatures and the difference in pressures. This curve fit produces a calibration function of the pressure difference as a function of at least the first temperature and the second temperature. This calibration function may be used in a variety of ways as will be appreciated by those skilled in the art.

For example, in some embodiments the first sensor and the second sensor may form a virtual differential pressure sensor. A virtual differential sensor may be a pair of sensors placed in different places so as to measure the pressure difference between them (i.e. the two separate sensors may be used instead of a dedicated differential pressure sensor such as the through-wall type mentioned above). The differential sensor is virtual in the sense that the two sensors are not physically linked, but rather their outputs are processed together to generate a differential pressure measurement. Each individual sensor could even be part of more than one virtual sensor. In some examples, the two sensors may be placed either side of a specified building zone boundary (i.e. one inside the zone and one outside the zone), e.g. one inside a building and one outside the building. In another example, the two sensors may be placed on either side of a fan in a ventilation unit so as to measure the pressure differential created by the fan. The virtual differential pressure sensor can be calibrated using the calibration function to effectively eliminate the temperature drift from the output of the virtual differential pressure sensor, for any specified measurement time. It may also be useful when comparing a larger system (e.g. a whole building ventilation system or a multi-building system), or when looking at multiple sensors placed in the same zone, to be able to calculate a calibrated pressure difference.

In some embodiments the method may further comprise, for a measurement time: obtaining a first pressure measurement from the first sensor; obtaining a second pressure measurement from the second sensor; obtaining a first temperature measurement corresponding to the first sensor; obtaining a second temperature measurement corresponding to the second sensor; and calculating a calibrated pressure difference by calculating the difference between the first pressure measurement and the second pressure measurement and subtracting the pressure difference from the calibration function based on the first temperature measurement and the second temperature measurement. In this way measurements (including historic and future measurements) can be adjusted to give a calibrated pressure difference which takes into account the drift by using the calibration function.

It will be appreciated by the skilled person that the temperature dependent drift in different pressure sensors will have different relationships. Some sensors may have a linear temperature dependent drift, some may have a quadratic temperature dependent drift, some a more complex polynomial relationship for temperature dependent drift, some an exponential relationship etc. Therefore the function used to perform the curve fit may vary. It may be determined based on a presumed form of the temperature dependence of each sensor. The form of the temperature dependence of a sensor may be provided by the manufacturer of the or each sensor. In some embodiments the temperature dependent drift may be quadratic, and may be represented in the following way:

$${P}_{1 , drift} = {a}_{1} {T}_{1}^{2} + {b}_{1} {T}_{1} + {c}_{1}$$

$${P}_{2 , drift} = {a}_{2} {T}_{2}^{2} + {b}_{2} {T}_{2} + {c}_{2}$$

so the quadratic equation representing the difference in pressure as a function of the first temperature and the second temperature becomes:

$$Δ {P}_{m e a s u r e d} = {a}_{1} {T}_{1}^{2} - {a}_{2} {T}_{2}^{2} + {b}_{1} {T}_{1} - {b}_{2} {T}_{2} + {c}_{1} - {c}_{2}$$

where T₁ is the temperature associated with the first sensor and T₂ is the temperature associated with the second sensor, a₁, a₂, b₁ and b₂, are the constants which define the function with the constant offset of c₁-c₂. It will be appreciated that the values of a₁, a₂, b₁ and b₂ can be calculated by performing the curve fit, leaving a constant offset of c₁-c₂.

The time period may be referred to as the first time period or the measured time period. The time period may be any time period when there is no active ventilation contributing to the difference in measured pressure between the two sensors. In some examples, the time period may be selected to be when all ventilation in a building is inactive (e.g. overnight when systems are switched off to save energy). The time period may comprise a plurality of separate time periods in which active ventilation does not contribute to differences in measured pressure between the first sensor and the second sensor (e.g. several time periods taken across several nights of data). It will be appreciated that once ventilation has been turned off, a building's zones will generally equalise in pressure at a rate that depends on the level of air sealing between those zones. In typical buildings, in which zones are not designed to be airtight, this can happen within a relatively short period, e.g. about 5 or 10 minutes simply by means of air flow through gaps and porosity in doors, walls, windows, rooves, stairwells, elevator shafts etc. There is therefore plenty of time during an overnight time period to acquire multiple data points for the curve fit. It is also likely that there will be a range of temperatures throughout such an overnight period.

Whilst a single determination of the calibration function may be sufficient, in some systems the effects of drift may change over time. The skilled person will appreciate that one major factor in drift of sensors is the degradation of components over long periods of time (i.e. months or years), which can affect the accuracy of sensors, and change the way pressure sensors drift due to other factors (e.g. temperature, humidity, etc.). Therefore, in some embodiments the calibration function may be updated over time. In some embodiments the calibration function may be updated or re-determined on a regular basis. This enables a more accurate long-term calculation of calibrated pressure difference to be performed. In some scenarios it may be that the calibration function is updated whenever a suitable time period is established (e.g. every night or even every time the ventilation systems have been switched off for more than 5 minutes). In some embodiments the updating of the calibration function may be performed in a rolling fashion against a plurality of the most recent times with appropriate conditions. For example, the calibration function may be updated every day to include the last three nights of data, or may be performed weekly to include time periods across the previous month. More generally, the calibration function may be periodically updated based on an updated time period. In this way the current calibration function can make use of an optimal amount of data while avoiding too much drift from other factors (e.g. sensor aging). Equally, if the calibration function is being applied to past measurements rather than to current measurements, the time period may be established relative to that measurement so that the calibration function is determined from an appropriate set of data points. For example, the past measurement could be arranged to be in the middle (in time) of a plurality of times which contribute to the calibration function.

It will be appreciated that it may be useful to be able to apply calibration functions to both current and historic measurements. Therefore, the method may include monitoring changes in the calibration function over time. The changes in the calibration function may help characterise and predict drift in the sensors due to sensor aging. An improved calibration function may be determined as a function of at least the first temperature, the second temperature and time. This can help provide a calibration function with increased accuracy. The calibration function may incorporate a time dependent drift factor using information from the changes in the calibration function over time, also helping to improve the compensation for drift of the first and second pressure sensor.

It will be appreciated that whilst the time period may be chosen by any reasonable means (e.g. by selection of specific times in advance, such as known schedules of building operation), it may also be useful to determine the time period based on other criteria. The method may include determining the time period by monitoring the measured first pressure and/or the measured second pressure for changes in pressure which are indicative of active ventilation turning on and off. Such changes in active ventilation typically produce a noticeable effect on the pressure within a zone. These changes may be detected by monitoring rates of change in the measured pressures, or by looking at absolute changes over time. This may be more reliable than using predetermined schedules and can ensure that the calibration measurements are taken at a time when the appropriate active ventilation is off. Determining the time period may include monitoring the first temperature and/or the second temperature. In a similar manner, when building systems move to an economy setting overnight, there may be detectable temperature changes at the sensors. It will also be appreciated that combinations of temperature and pressure may be used to determine the start and/or end of a suitable time period with no active ventilation. In other examples, the time period may be determined from information provided by a building management system indicating that there is no active ventilation in the locations where the first sensor and the second sensor are located. For example, an output signal from the building management system may be provided to the sensor calibration system to indicate the status of the active ventilation. It will be appreciated that any combination of the above may be used to contribute to the determination of the time period. The time period may be determined before or after pressure and/or temperature measurements are taken. In some embodiment's historic determinations of the time period may be used to determine a future time period (e.g. a building schedule may be determined form historic data and used to identify future suitable time periods).

As discussed above, after a ventilation system has been turned off, there may be a stabilisation period. Therefore, in some embodiments the time period begins after a stabilisation period has elapsed after active ventilation has stopped (or after the stoppage of active ventilation has been detected). The stabilisation period will depend on various factors such as the size of the zones and the degree to which they are sealed from each other (e.g. the rate of air exchange between them). In some examples, this may be less than 1 minute, or it may be up to 5 minutes, or it may be longer than 5 minutes, e.g. up to 10 minutes, up to 30 minutes or even up to 1 hour. Therefore, in some examples, the stabilisation period may be selected from: at least 1 minute, at least 5 minutes, at least 10 minutes, at least 30 minutes or at least 1 hour.

Ideally, pressure and temperature measurements from the two sensors will be taken at the same time for the most accurate measurement. This may be achieved easily in a system where all sensors are hard-wired to a central controller which can centrally control the timings of measurements. However, in many cases such centralised control is not practical, especially in retro-fitted systems. Also, where it is desirable (for ease of installation) to avoid drilling holes through walls, such centralised control may be less practical. Wireless sensors may be used instead. Battery operated sensors may be used which can take readings periodically and report them (e.g. wirelessly) back to a central computer. Synchronised measurements may still be possible with such systems by sending an instruction to both sensors simultaneously to acquire a reading. However, it will be appreciated that in some examples it may be beneficial to employ sensors which operate independently. In such cases, data from different sources (e.g. different sensors) may be acquired according to different clocks, i.e. the measurements may not be taken simultaneously. For example the first sensor and the second sensor may each have their own internal clocks which are used to acquire sensor readings. To help compensate for any discrepancies between sensor timings, in some embodiments the first pressure, second pressure, first temperature and second temperature data may be synchronised onto a common time clock. In some embodiments the method may comprise resampling the data at time points of the common clock. This may involve interpolating between measurements so as to estimate a sensor reading at the required common time point.

As discussed above, a main factor that causes drift in pressure sensors, is temperature (i.e. the temperature of or around the pressure sensor). Therefore, to compensate for drift in pressure sensors, the temperature of the pressure sensors or of the local environment around those pressure sensors is also required, i.e. the temperature associated with each sensor. The temperature may be obtained from an independent source, or it may be obtained from temperature sensors that are integrated with the pressure sensors (for example a combined pressure/temperature sensor unit). Therefore, in some embodiments the first sensor is configured to detect both the first pressure and the first temperature and/or the second sensor is configured to detect both the second pressure and the second temperature. It will be appreciated that if the first and second sensors are located in close vicinity to each other, the first temperature associated with the first sensor may be the same as the second temperature associated with the second sensor. However, in many scenarios, the first and second sensors will not be in the same location (e.g. they may be in different zones, e.g. one inside, one outside a building), the first temperature and the second temperature will be different.

Whilst temperature drift may be a dominant factor in pressure sensor drift, other atmospheric variables may also contribute to drift of a pressure sensor, for example humidity. Humidity may be particularly relevant when looking for differential pressures between the inside and outside of a building in locations with high average humidity, or with changing humidity levels. In some embodiments the data may further comprise a plurality of values of each of a first humidity associated with the first sensor and a second humidity associated with the second sensor. The method may further comprise: for each of the plurality of times in the time period, obtaining from the data: the first humidity at that time, the second humidity at that time; and performing the curve fit analysis to obtain a calibration function of the pressure difference as a function of the first humidity and the second humidity. In this way humidity changes can be incorporated into the calibration function along with temperature and any other relevant factors (e.g. time as discussed above).

As discussed above, the first and second pressure sensors may be located at different heights. The difference in height of the two sensors will also contribute to the differences in their measurements. As this will affect the actual pressure experienced at the sensors, this difference will remain when the active ventilation is switched off. However, in such examples, measurements of the height of each sensor may be obtained (these may be obtained in advance in an installation set-up process) and the pressure due to the height difference may be calculated using well known barometric formulae so that this difference may be removed when calibrating the sensors for drift. The process can then proceed as above.

Accordingly, in some embodiments the data may include a first height associated with the first sensor and a second height associated with the second sensor, and the calibration function may be a function of the first height and the second height (i.e. in addition to being a function of the first temperature and the second temperature). The first height may be the height at which the first sensor is installed and the second height may be the height at which the second sensor is installed (e.g. height above sea level), however in some embodiments the first and second heights may be relative heights between the locations of the first and second sensor. This allows sensor placement in buildings to be more flexible, and may help reduce costs of installation.

The stack effect can also have a significant effect on the pressures measured at the first sensor and the second sensor. By appropriate modelling, it may be possible to determine the magnitude of the stack effect on the measurements and thus remove it from the measurements before calibrating (in much the same way as discussed above for height compensation). In many cases, the stack effect may not be significant or it may be possible to determine times at which the stack effect is not significant (e.g. by determining that the temperature profile of the building is uniform). Calibration measurements (i.e. for determining the calibration function) may thus be taken at appropriate times when the stack effect does not contribute to pressure differences between the first sensor and the second sensor. In some embodiments, the time period may be selected to be at a time (or several times) when the temperature of the first sensor and the temperature of the second sensor are the same, or at least within a predetermined threshold of each other. When the temperature in two adjacent zones is the same, there will be no stack effect between them. For example, as discussed above, the stack effect has opposite effects in winter and summer due to the different relative temperature profiles (whether the building is warmer or cooler than the outside air). However, at times of transition between these two states, there will be no stack effect and at such times it is particularly advantageous to perform a calibration. Therefore, some embodiments include determining that there is no (or no significant) stack effect and performing the calibration procedure responsive to that determination. Such events may occur relatively rarely, e.g. twice a year at the transitions between winter and summer conditions, although they can occur at other times of the year between hot periods and cold periods. As calibration in such conditions may be particularly accurate and beneficial, active ventilation may be turned off when such conditions are detected so as to ensure that the absence of stack effect can be combined with an absence of active ventilation. After an appropriate stabilisation period, calibration can then be performed as discussed above.

Although many of the examples discussed above are in relation to zones such as rooms or floors (i.e. zones with physical boundaries such as walls, roofs, doors and windows), zones can be created in other ways. In other examples, the first sensor and the second sensor may be located at different points in a ventilation system, for example either side of a fan. As the fan increases the pressure on one side and decreases pressure on the other, it effectively divides two zones. When the fan is inactive, such sensors either side of the fan may be considered to be within the same zone as the fan is no longer creating a pressure difference. It will be appreciated that when in such close proximity the sensors may often be installed at the same height (or close enough to be effectively at the same height), so it may be considered that the difference between the measured pressures should be the same when the fan is off and therefore accurate calibration can be performed at such times. In such circumstances it may not be necessary to compensate for any effects such as the stack effect or height differences and the stabilisation time may be much shorter (e.g. no more than 30 seconds or even no more than 10 seconds.

It will be appreciated that different steps of the method may all be performed by a single system or may be distributed across different systems. For example, the first and second sensors may provide data to a first system which may perform the calibration procedure or may transfer data to a second, separate system for calibration. For example, the calibration may be performed by a cloud service. The calibration function (once determined) may be sent to the first system (e.g. a local system) for application to sensor measurements so as to remove the drift appropriately and therefore provide more accurate measurements.

According to a second aspect of the present invention, a system for compensating for pressure measurement drift is provided. The system comprising:
a first sensors configured to measure a first pressure;
a second sensor configured to measure a second pressure;
a processor; and
a memory;
wherein the memory comprises instructions which when executed by the processor cause the processor to:
   acquire data during a time period in which active ventilation does not contribute to differences in measured pressure between the first sensor and the second sensor, the data comprising a plurality of values of each of: the first pressure; a first temperature associated with the first sensor; the second pressure; and a second temperature associated with the second sensor;
   for each of a plurality of times in the time period, obtain from the data;
      i) the first temperature at that time,
      ii) the second temperature at that time, and
      iii) a pressure difference between the first pressure at that time and the second pressure at that time; and
   perform a curve fit analysis to obtain an estimate of the pressure difference as a function of at least the first temperature and the second temperature.

It will be appreciated that all data acquired by the first and/or second sensor may include more data than the data for the time period. Data may be provided from the sensors on a more continual basis (e.g. as it is produced), or may be retrieved from the first and/or second sensors on a periodic basis (e.g. hourly or every few minutes). Such measurements can be corrected by the determined calibration function even when active ventilation is operational. The system may be integrated with a ventilation system and/or may be separate from a ventilation system.

In some embodiments the system may comprise at least three sensors, each of which is configured to measure pressure, wherein for each combination of two sensors in the at least three sensors, one is determined to be the first sensor, and the other is determined to be the second sensor; and wherein the instructions are executed by the processor for each determined first sensor and second sensor. It will be appreciated that in systems of at least three sensors, drift can be compensated for any pair of the sensors, allowing multiple calibrations to be performed for each individual sensor. Each calibration function may be used to provide a starting point for other calibration functions using the same sensor. The overall computational power required for the determination of each calibration function can therefore be reduced, increasing the efficiency of the system. In addition, with each parallel calibration function, the calibration for an individual sensor may be more accurate.

It will be appreciated that the features described above in relation to the first aspect may equally be applied to the second aspect. In particular the method of the first aspect relates to the steps which may be carried out by the processor in the second aspect. Similarly features of the system of the second aspect may be applied to the first aspect relating to the method.

In accordance with a third aspect, a ventilation system is provided comprising the system for compensating for pressure measurement drift as outlined above.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

Certain preferred examples of this disclosure will now be described, by way of example only, with reference to the accompanying drawings, in which:

FIG. 1 is a schematic illustration of a building which can employ embodiments of the present invention;

FIGS. 2A and 2B show schematics of the building of FIG. 1 split into zones;

FIGS. 3A and 3B show how temperature differences between inside and outside affect air flow in a building;

FIG. 4 shows a schematic of a system according to an embodiment of the present invention;

FIG. 5 is a flowchart showing the method of calculating measurement drift in accordance with one embodiment of the present invention;

FIG. 6 is a plot showing measured differential pressure across an air inlet filter and corresponding times when an air handling unit is inactive;

FIGS. 7A and 7B show 3D plots of example curves showing the relationships between temperature and pressure difference; and

FIG. 8 is a plot showing differences in measured pressure, and the same differences once calibrated in accordance with embodiments of the present invention.

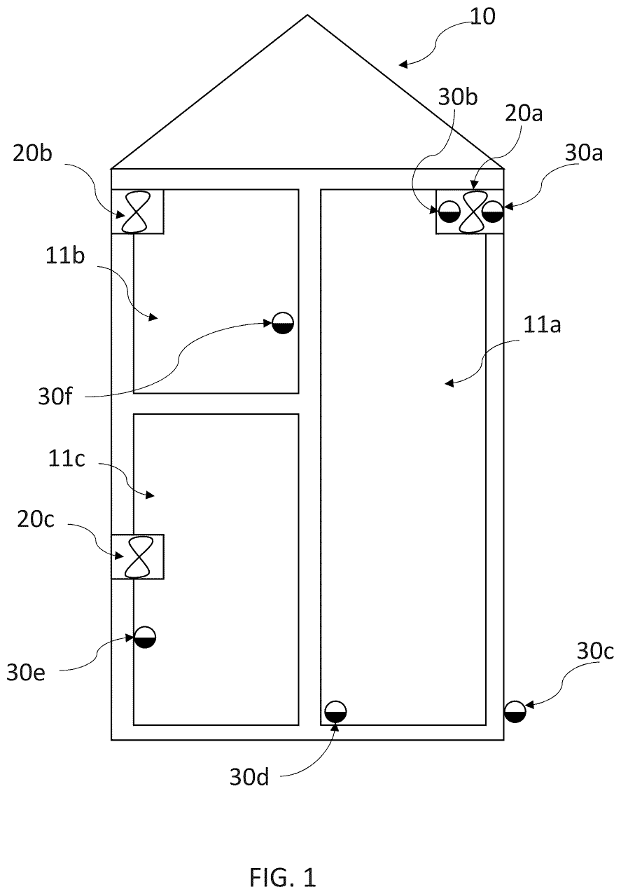

FIG. 1 shows a building 10, with three separate areas 11a, 11b and 11c treated by a ventilation system as separate ventilation zones. Each area 11a, 11b, 11c has a respective air handling unit 20a, 20b, 20c which includes a fan, and is used to control temperature and pressure within the respective ventilation zone. The building 10 has a number of sensors 30a-30e, which are each configured to measure both pressure and temperature. In each ventilation zone there is a sensor 30f, 30e, 30d which is used to monitor temperature and pressure within said zone. A sensor 30c is also placed outside of the building 10, to monitor current atmospheric conditions. One of the air handling units (AHU) 20a, has two sensors 30a and 30b, one placed on either side of the fan. Sensors 30a and 30b in AHU 20a are used to monitor the changes in pressure across the fan, which allows operation of the fan to be monitored.

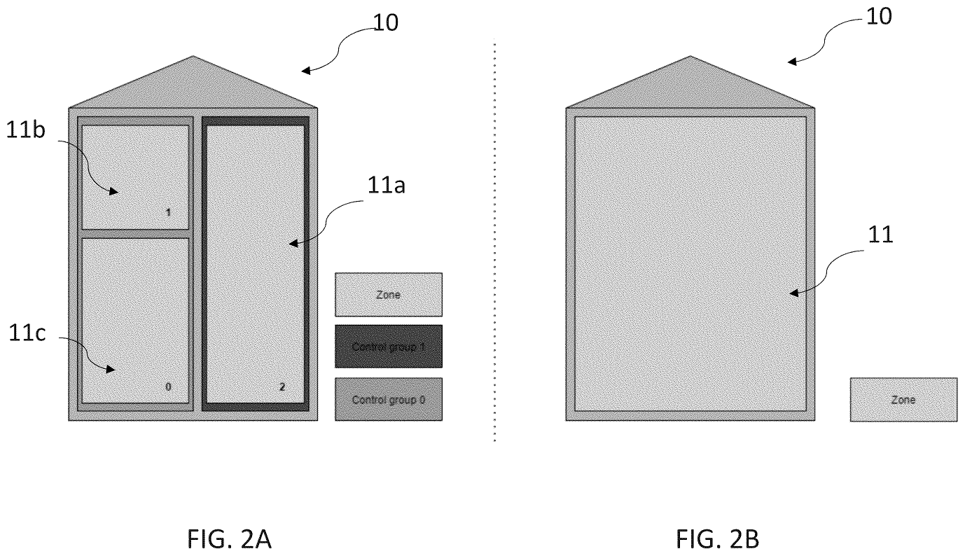

FIGS. 2A and 2B show the building of FIG. 1 with different ventilation zones being operated. In FIG. 2A there are three zones, 11a, 11b and 11c. Zones 11b and 11c are operating under the same ventilation control group, but are still physically separated into two zones. In the same way as shown in FIG. 1, zone 11a is acting as a single ventilation zone. When active ventilation is turned off, there is no longer any active control over air flow in the building 10, and the building 10 becomes a single zone 11 as shown in FIG. 2B. This is because without active ventilation to maintain pressure differences, air will flow freely between different areas, for example through ventilation ducts, leakages especially at doorways, elevator shafts and windows, etc. and will gradually equalise across zones. Once ventilation has been turned off, the effects of natural draft (the stack effect) will be the predominant factor in determining pressure differences between the inside and outside of the building. The degree of air movement due to the stack effect depends on temperature, humidity and height above ground level. The stack effect predominantly occurs when there is a temperature differential between the inside of the building 10 and the outside of the building, but other atmospheric differences also contribute. The stack effect is at its largest when there are large differences between internal and external temperatures (e.g. in the winter, or in the summer). In these circumstances, during normal building operation, temperatures are unlikely to equalise even when the heating and ventilation systems are turned off (or turned down) overnight.

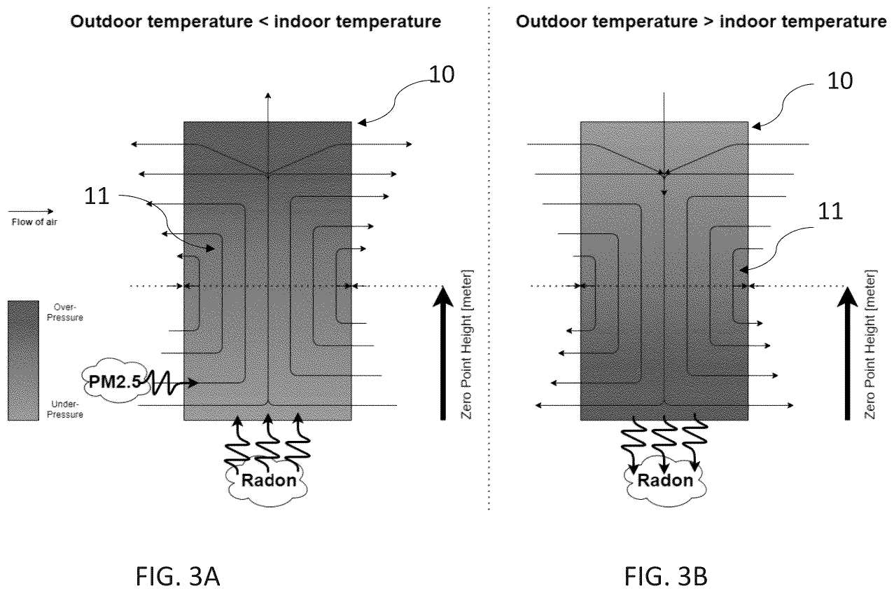

FIGS. 3A and 3B show a building 10 with a single zone 11 and illustrate the stack effect. In FIG. 3A the zone 11 is at a higher temperature than the outdoor temperature. Air within the zone 11 rises, which results in an overpressure at the top and an under-pressure at the bottom. The pressure at the top of the zone 11 is higher than the outside pressure, so air leaks out of the building (carrying heat with it). Meanwhile, cold air is drawn in at the bottom of the building where the pressure inside the zone 11 is lower than the outside pressure. As shown in the figure, this under-pressure can also cause radon and particulate matter to be drawn into the building. At a height half way up the area 11, the air pressure inside is the same as the air pressure outside and there is no air movement across the building envelope. In contrast, in FIG. 3B the zone 11 is at a lower temperature than the outdoor temperature. Cooling air falls within the zone 11 resulting in an overpressure at the bottom so that the cold air leaks out of the building (and radon gas may be suppressed from entering the building), while there is an under-pressure at the top causing warm air to be drawn in. Again, there is a “zero point height” half way up where there is no air transfer across the building envelope. Ventilation systems can be used to control the air flow within zones of the building to optimise conditions. For example, ventilation can be used to move the “zero point height” up or down within the zone or can even move it outside of the zone completely, resulting in a fully over-pressure or fully under-pressure zone. Such control can be used to reduce energy loss and reduce costs for heating/cooling the building. In order to control the ventilation optimally, the system ideally measures and monitors the pressure differential across the zone envelope.

It will be appreciated that whilst the examples of FIGS. 3A and 3B have the building 10 as a single zone, the same principles apply to control of multiple zones such as shown in FIGS. 1 and 2A.

Sensors 30a-30e are located throughout and around the building 10 as shown in FIG. 1. These sensors can be used in various applications relating to the ventilation systems. In particular, the sensors 30a-30e can be used together to provide measurements of differential pressure that can be used to control the ventilation systems.

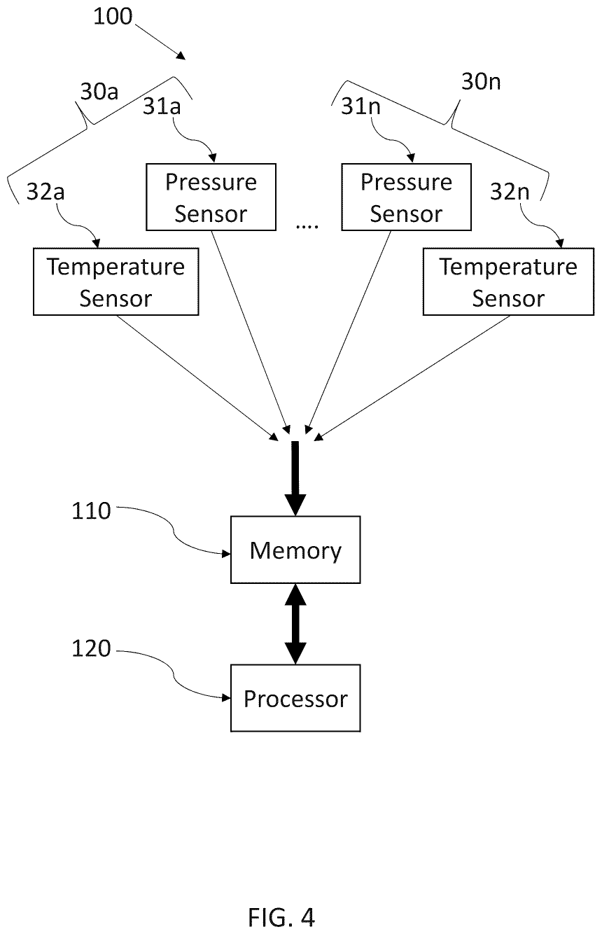

FIG. 4 shows a system 100, which has sensors 30a-30n. FIG. 4 only shows two such sensors, but it will be appreciated that any number may be provided. Each sensor includes both a pressure sensor 31a-31n and a temperature sensor 32a-32n. Data collected by the sensors 30a-30n is transferred to a memory 110 and analysed by processor 120. It will be appreciated that each sensor 30a, 30n may have its own memory for storing data locally if desired. Each sensor 30a, 30n may operate independently of the other sensors 30a-30n and may operate based on its own independent clock. Accordingly, when sensor readings from several sensors are combined (e.g. in memory 110 by processor 120), the readings may be combined onto a common time reference. In such arrangements, it cannot be guaranteed that readings will be taken simultaneously from all sensors and so the processing may interpolate between readings so as to obtain a set of readings (one for each sensor) for each selected time point on the common time reference.

The system 100 shown in FIG. 4 may be an independent system which can provide data to other building systems. However it will be appreciated that the system 100 may also be incorporated into another building system, for example a ventilation system and/or a building management system.

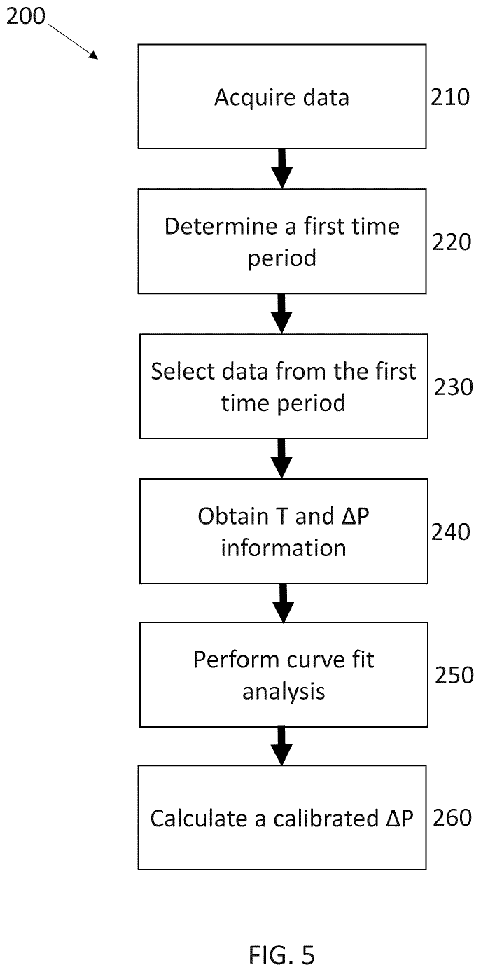

FIG. 5 is a flow chart of a method 200 of how to compensate for pressure measurement drift in two sensors 30a-30n so as to provide an accurate measurement of differential pressure between the two sensors. The method 200 can be performed by the processor 120 as described above with reference to FIG. 4. The method 200 outlines how pairs of pressure sensors 30a-30n are calibrated to obtain a calibrated value of the pressure difference between the two sensors so that together they can act as a virtual differential pressure sensor.

In step 210 data is acquired, from which the calibration function is determined. The data includes pressure measurements from both a first sensor and a second sensor (i.e. first pressure and second pressure), as well as temperature measurements from the first sensor and second sensor (i.e. first temperature and second temperature). The data can also include information on other variables which affect pressure measurements, including the height at which the sensors are placed (or the difference in their heights) and humidity values at each sensor (i.e. first humidity and second humidity).

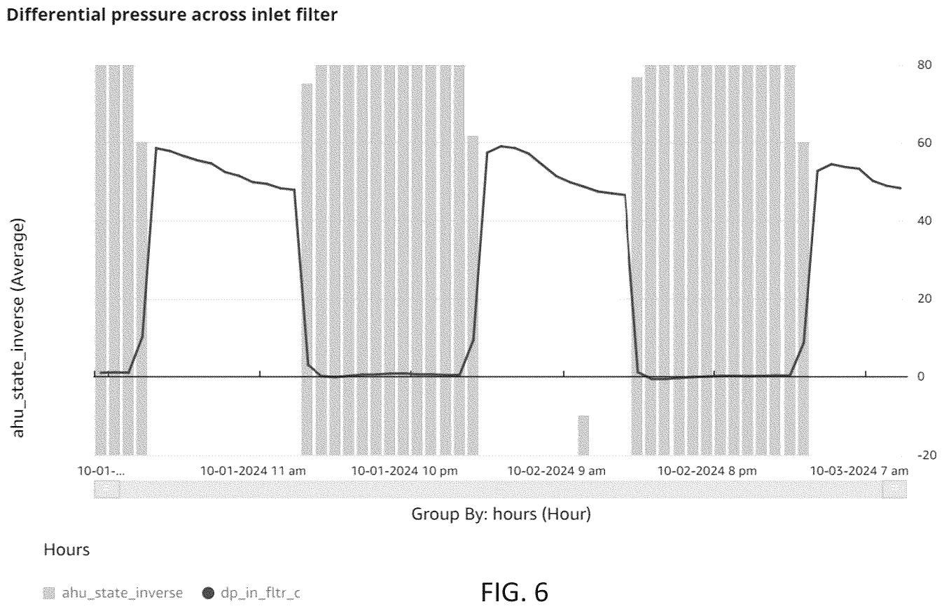

The data acquired in step 210 may be acquired continually (e.g. throughout the day). However, the calibration function for the pair of sensors is performed at times when active ventilation does not contribute to the differences in measured pressure between the two sensors. Thus in step 220, a time period is determined during which active ventilation does not contribute to pressure differences. If the two sensors are in the same ventilation zone in a building, this time period can include times when the building (active) ventilation is on, provided that it does not contribute to the differences between the pressure at both sensors. However, in many circumstances the two sensors will not be in the same ventilation zone, so the time period for determining the calibration function will be when the ventilation system has been turned off, e.g. overnight or at a weekend, or by specific command. The system may wait for a time after ventilation switches off so as to allow time for pressures to equalise. For example, 10 minutes may be enough in many buildings. The switching off of active ventilation can be determined in a number of ways, including with information provided directly from a ventilation control system, or building management system. However, if the calibration system is not directly linked with these systems, the time period can alternatively be determined directly from the acquired data as shown in more detail in FIG. 6, e.g. by identifying rapid changes (steep gradients) in the pressure data.

In FIG. 6, the bars show times when a ventilation system is active (note that the bars shown on the graph are inverse, i.e. a high value means that the ventilation is off). The line graph in FIG. 6 shows the measured pressure difference between two sensors placed either side of a fan in an AHU controlled by the ventilation system (for example sensors 30a and 30b as shown in FIG. 1). Either set of data can be used to determine the calibration time period of step 220 of FIG. 4 (or indeed both sets of data can be used). The bars are data obtained directly from the ventilation control system and can thus provide a direct trigger from which to determine the calibration time period. Alternatively, the line graph shows that when the ventilation system is switched between on and off there is a sudden and significant change in the measured pressure difference across the air handling unit. This sudden change is easily measurable (e.g. using threshold values and by detecting the steep gradient), and can be used to indicate when there is a change in the state of the ventilation without the need to obtain information directly from the ventilation system itself. Whilst in this example the measured difference between two sensors is used, in other examples data from an individual pressure sensor can be used provided it experiences similar changes in pressure when ventilation becomes active or inactive. As can be seen in FIG. 6, the ventilation system cycles every day, with each day having periods of active ventilation (daytime) and periods of inactive ventilation (night time). The time period can include one or more periods with active ventilation not contributing to pressure differences, i.e. it can include data across multiple days, e.g. by combining several night time periods together.

Returning to the method shown in FIG. 5, after the time period has been determined, data from that time period is selected in step 230. Data selection may simply be taking data that falls within the determined first period. However, as discussed above, data may be selected and merged onto a common time clock, so that for a plurality of times in the time period, a pressure and temperature value corresponding to each sensor is selected (and where relevant other variables like humidity are also selected). Merging data onto a common time clock may involve resampling and/or interpolation. The result of this data selection step 230 is a plurality of time points, each with a temperature value and a pressure value for each sensor (i.e. for each time point there is a first pressure, first temperature, second pressure and second temperature).

At step 240, pressure differences (difference between the two sensors) and temperature values for each sensor are obtained for each of the plurality of times in the data. Other information (e.g. humidity readings) may also be gathered for both sensors.

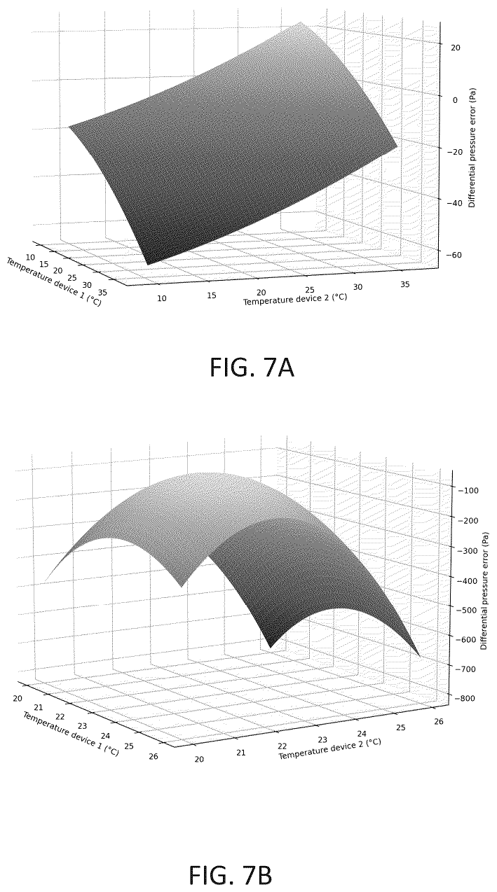

At step 250, a curve fit analysis is performed to obtain a calibration function of the pressure difference as a function of the first temperature and second temperature (i.e. as a function of the temperatures of both sensors), and optionally also as a function of any other variables used such as first humidity and second humidity. The calibration function can be plotted visually as a three-dimensional plot. Two examples of such calibration functions are shown in FIGS. 7A and 7B. Each of these figures represents a different pair of sensors. It can be seen that the shape of the two functions is quite different, as it depends on the measurement drifts of both of the sensors. As will be appreciated, if data for only a small number of times within the time period is available, a less accurate curve-fit may be obtained, whereas including more data will allow a more accurate curve fit to be performed. The curve fit may take a number of different forms, but in the examples shown in FIGS. 7A and 7B the sensors are known to have a pressure drift that is quadratic with temperature. Therefore, in these examples, the curve fit attempts to fit a curve of the form:

$$Δ {P}_{m e a s u r e d} = {a}_{1} {T}_{1}^{2} - {a}_{2} {T}_{2}^{2} + {b}_{1} {T}_{1} - {b}_{2} {T}_{2} + {c}_{1} - {c}_{2}$$

where ΔP_{measured} is the pressure difference between the first pressure and the second pressure, T₁ is the temperature associated with the first sensor, T₂ is the temperature associated with the second sensor and a₁, a₂, b₁, b₂ and c₁-c₂, are the constants to be determined by the curve fitting.

The curve-fit analysis is simplified in the scenario where pressure difference is also not caused by temperature induced air flow in the zone (for example when the inside of the building is the same temperature as the outside). This is because when the temperatures inside and outside a zone are the same, there is no (or no significant) stack effect which means that the pressure sensor drifts should be the only cause of pressure difference between two equal height sensors. If the two sensors are at different heights then there will also be a difference due to that height difference, but this can be accurately calculated from standard barometric formulae and can easily be subtracted providing the sensor heights are known.

Returning to the flow chart of FIG. 5, once the curve fit analysis of step 250 has been completed, the calibration function can then be used to calculate a calibrated difference in pressure between the two sensors in step 260. In particular, once the calibration curve has been obtained, it can be used to find the pressure difference due to drift in current temperature conditions. This can be done, even while ventilation is active, so as to provide a more accurate pressure difference measurement throughout the day. For example, by reading the current temperature of each sensor, and using these as inputs to the calibration function, the calibration function will return the pressure difference that is due to the combined sensor drifts and this can be subtracted from the actual measured pressure difference for a more accurate pressure difference reading.

When a pressure differential is needed by the ventilation system or building management system, the most recent calibration function can be used to determine a calibrated pressure differential. The calibration function can be updated over time to ensure it remains accurate. For example, the calibration function may be updated periodically, e.g. every time a new period of inactive ventilation is available. Changes in the calibration function over time can also be used to monitor aging of the sensor, which is a further cause of sensor drift.

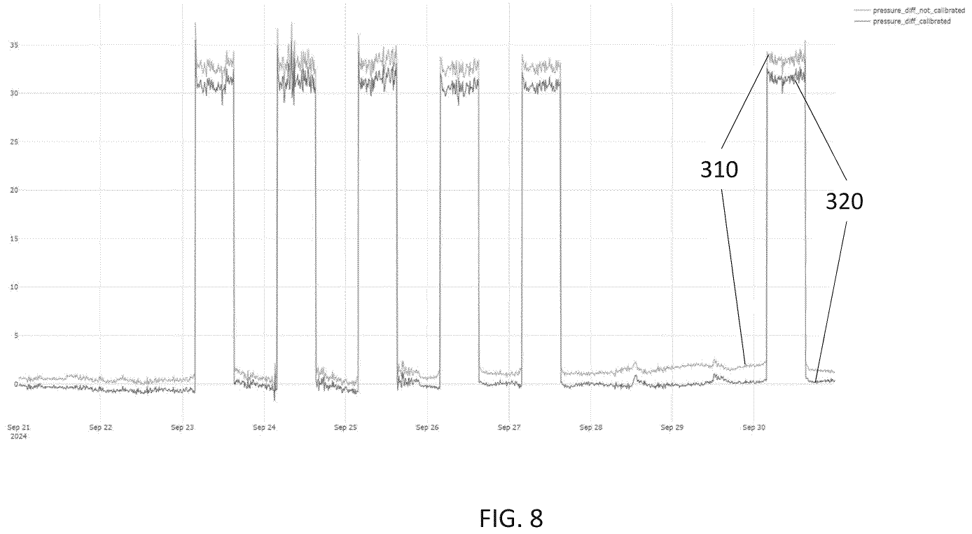

FIG. 8 shows a comparison to illustrate the benefits of the calibration according to this invention. FIG. 8 shows the pressure difference calculated from two absolute pressure sensors with no calibration 310 (upper line) and also shows the pressure difference between the same two absolute pressure sensors once calibrated using the invention 320 (lower line). FIG. 8 shows a period of just over a week during which the ventilation switches between an active state (during the working day) and an inactive state (during the night and at the weekend). The pressure sensors thus measure a big pressure difference across the building envelope during the day when the active ventilation is contributing to the pressure difference, but show a near zero pressure difference at night and at the weekend when the pressure has equalised between zones. In this example, the calibration was performed only as a function of temperature. It is shown that the calibrated pressure differential 320 is shifted in comparison to the uncalibrated data 310. It can be seen clearly in FIG. 8 that the upper line 310 (uncalibrated) is consistently higher, i.e. there is a systematic error. Even when the active ventilation is off, the pressure difference is not at zero (even though it should be). By contrast, the calibrated pressure differential 320 (lower line) clearly measures a zero pressure difference during the nights and weekend, i.e. it much more accurately reflects the real situation when there is no pressure difference between the sensors. The calibrated curve achieves this improved accuracy because it has removed the effect of temperature drift in this pair of sensors.

Whilst the steps of the method of FIG. 5 have been described in a particular order, it will be appreciated that the steps may be taken in different orders, and that some steps may be repeated when the calibration function is updated. For example, in this example the first step 210 is acquiring data, however in other examples the time period may be determined (e.g. based on other information such as a building ventilation schedule) before data acquisition in step 210. Steps may equally be performed simultaneously, for example where the curve fit analysis is continually updated to include new data.

It will be appreciated by those skilled in the art that the disclosure has been illustrated by describing one or more specific aspects thereof, but is not limited to these aspects; many variations and modifications are possible, within the scope of the accompanying claims.

1. A method for compensating for pressure measurement drift of a first sensor and a second sensor, wherein the drift is at least partially temperature dependent, and wherein the first sensor is configured to measure a first pressure and the second sensor is configured to measure a second pressure, the method comprising:
acquiring data during a time period in which active ventilation does not contribute to differences in measured pressure between the first sensor and the second sensor, the data comprising a plurality of values of each of: the first pressure; a first temperature associated with the first sensor; the second pressure; and a second temperature associated with the second sensor;
for each of a plurality of times in the time period, obtaining from the data:
i) the first temperature at that time,
ii) the second temperature at that time, and
iii) a pressure difference between the first pressure at that time and the second pressure at that time; and
performing a curve fit analysis to obtain a calibration function of the pressure difference as a function of at least the first temperature and the second temperature.

2. A method as claimed in claim 1, wherein the first sensor and the second sensor are located within different ventilation zones.

3. A method as claimed in claim 2, wherein the time period is selected to be at a time when a temperature profile in the different ventilation zones is substantially the same.

4. A method as claimed in claim 1, wherein the first sensor is inside a building and the second sensor is outside the building.

5. A method as claimed in claim 1, wherein the first sensor and the second sensor form a virtual differential pressure sensor.

6. A method as claimed in claim 1, further comprising, for a measurement time:
obtaining a first pressure measurement from the first sensor;
obtaining a second pressure measurement from the second sensor;
obtaining a first temperature measurement corresponding to the first sensor;
obtaining a second temperature measurement corresponding to the second sensor; and
calculating a calibrated pressure difference by calculating the difference between the first pressure measurement and the second pressure measurement and subtracting the pressure difference from the calibration function based on the first temperature measurement and the second temperature measurement.

7. A method as claimed in claim 1, wherein the time period comprises a plurality of time periods in which active ventilation does not contribute to differences in measured pressure between the first sensor and the second sensor.

8. A method as claimed in claim 1, wherein the calibration function is updated over time.

9. A method as claimed in claim 8, further comprising:
monitoring changes in the calibration function over time, wherein an improved calibration function is determined as a function of at least the first temperature, the second temperature and time.

10. A method as claimed in claim 1, wherein the method further comprises:
determining the time period by monitoring the measured first pressure and/or the measured second pressure for changes in pressure indicative of active ventilation turning on and off.

11. A method as claimed in claim 10, wherein the time period begins after a stabilisation period has elapsed after active ventilation has stopped.

12. A method as claimed in claim 1, wherein the method comprises:
determining the time period from information provided by a building management system indicating that there is no active ventilation in the locations where the first sensor and the second sensor are located.

13. A method as claimed in claim 12, wherein the time period begins after a stabilisation period has elapsed after active ventilation has stopped.

14. A method as claimed in claim 1, wherein the first pressure, second pressure, first temperature and second temperature data are synchronised onto a common time clock.

15. A method as claimed in claim 14, wherein the method further comprises resampling the data at time points of the common time clock.

16. A method as claimed in claim 1, wherein the first sensor is configured to detect both the first pressure and the first temperature and/or wherein the second sensor is configured to detect both the second pressure and the second temperature.

17. A method as claimed in claim 1, wherein the data further comprises a plurality of values of each of a first humidity associated with the first sensor and a second humidity associated with the second sensor; and wherein the method further comprises:
for each of the plurality of times in the time period, obtaining from the data:
the first humidity at that time,
the second humidity at that time; and
performing the curve fit analysis to obtain a calibration function of the pressure difference as a function of the first humidity and the second humidity.

18. A method as claimed in claim 1, wherein the first sensor is installed at a first height, the second sensor is installed at a second height and the calibration function is also a function of the first height and the second height.

19. A system for compensating for pressure measurement drift, the system comprising:
a first sensor configured to measure a first pressure;
a second sensor configured to measure a second pressure;
a processor; and
a memory;
wherein the memory comprises instructions which when executed by the processor cause the processor to:
acquire data during a time period in which active ventilation does not contribute to differences in measured pressure between the first sensor and the second sensor, the data comprising a plurality of values of each of: the first pressure; a first temperature associated with the first sensor; the second pressure; and a second temperature associated with the second sensor;
for each of a plurality of times in the time period, obtain from the data;
i) the first temperature at that time,
ii) the second temperature at that time, and
iii) a pressure difference between the first pressure at that time and the second pressure at that time; and
perform a curve fit analysis to obtain an estimate of the pressure difference as a function of at least the first temperature and the second temperature.

20. A system as claimed in claim 19, wherein the system comprises at least three sensors, each of which is configured to measure pressure, wherein for each combination of two sensors in the at least three sensors, one is determined to be the first sensors, and the other is determined to be the second sensor; and wherein the instructions are executed by the processor for each determined first sensor and second sensor.
